(19) United States
(12) Patent Application Publication
(10) Pub. No.: US 2012/0105501 A1
(43) Pub. Date: May 3, 2012

(54) IMAGE DISPLAY DEVICE AND METHOD FOR DRIVING IMAGE DISPLAY DEVICE

(75) Inventors: Norihiro NAKAMURA, Mobara (JP); Kenta KAJIYAMA, Yotsukaido (JP); Hajime AKIMOTO, Kokubunji (JP); Kouji IKEDA, Chiba (JP)

(73) Assignees: CANON KABUSHIKI KAISHA; Hitachi Displays, Ltd.

(21) Appl. No.: 13/281,585

(22) Filed: Oct. 26, 2011

(30) Foreign Application Priority Data
Oct. 29, 2010 (JP) 2010-243204

(51) Int. Cl. G09G 5/10; G09G 3/30

(52) U.S. Cl. 345/690; 345/77

(57) ABSTRACT

An image display device includes: a light-emitting element that emits light corresponding to an amount of current in an emission period; a storage capacitor to which a display potential is supplied to one end thereof before the emission period and which stores a voltage corresponding to the display potential; a driving transistor that adjusts an amount of current flowing in a drain electrode thereof in accordance with the voltage stored by the storage capacitor; a lighting control switch which is connected in series with the light-emitting element from the drain electrode of the driving transistor and which is turned on in the emission period; and a discharge switch that connects a node in a current path from the driving transistor to the light-emitting element, through which a current flows when the lighting control switch is turned on, to a wiring that supplies a discharge potential before the emission period.

### CROSS-REFERENCE TO RELATED APPLICATION

The present application claims priority from Japanese application JP2010-243204 filed on Oct. 29, 2010, the content of which is hereby incorporated by reference into this application.

### BACKGROUND OF THE INVENTION

1. Field of the Invention

The present invention relates to an image display device using a light-emitting element and a method for driving the image display device.

2. Description of the Related Art

In recent years, image display devices, such as an organic EL display device, using a light-emitting element have been actively developed. An example of a pixel circuit that causes a light-emitting element to emit light at a luminance corresponding to a grayscale and a method for driving the pixel circuit is disclosed in the specification of US 2007/0132693. FIG. 10 is a diagram showing an example of a pixel circuit of the related art. The pixel circuit includes a light-emitting element IL, a driving transistor TRD, a storage capacitor CP, a select switch SWS, an emission signal control switch SWF, a lighting control switch SWI, and a reset switch SWR. Moreover, a data line DAT and a power line PWR are formed so as to correspond to each column of the pixel circuits, and an emission control signal line REF is formed so as to correspond to each row of the pixel circuits. The driving transistor TRD is a p-channel transistor.

The transistor TRD has a source electrode that is connected to the power line PWR, a drain electrode that is connected to one end of the light-emitting element IL through the lighting control switch SWI and a gate electrode. One end of the storage capacitor CP is connected to the gate electrode of the driving transistor TRD, and the other end of the storage capacitor CP is connected to the data line DAT through the select switch SWS. Moreover, the other end of the storage capacitor CP is connected to the emission control signal line REF through the emission signal control switch SWF. The select switch SWS, the emission signal control switch SWF, the lighting control switch SWI, and the reset switch SWR are thin-film transistors. The gate electrodes of these thin-film transistors are connected to wirings through which a control signal is transmitted. Here, a node at the position of the gate electrode of the driving transistor TRD will be referred to as a node NA.

A method for driving the pixel circuit of an organic EL display device shown in FIG. 10 will be described. In a period of writing a data signal, the data line DAT supplies the data signal to the other end of the storage capacitor CP. During the period, the reset switch SWR is turned on, thus a potential difference between the gate and the source of the driving transistor TRD becomes the threshold voltage of the driving transistor TRD. When the reset switch SWR is turned off, the storage capacitor CP stores a voltage corresponding to a potential difference between the data line and the gate of the driving transistor TRD. After the period of writing the data signal, there is a period in which the light-emitting element is caused to emit light. In the period in which the light-emitting element is caused to emit light, the select switch SWS is turned off, the emission signal control switch SWF is turned on, and the lighting control switch SWI is turned on. By doing so, the emission control signal line REF supplies an emission control signal to the other end of the storage capacitor CP, so that the potential difference between the gate and the source of the driving transistor TRD becomes a sum of the threshold voltage and the data signal subtracted by the emission control signal. If the threshold voltage does not change with time, the light-emitting element IL emits light at a luminance determined by the potential difference between the data signal and the emission control signal regardless of the value of the threshold voltage of the driving transistor TRD.

In the respective pixel circuits of an image display device, a parasitic capacitor is generated on a current path from the drain electrode of the driving transistor to the light-emitting element. The parasitic capacitor is generated, for example, between both ends of the light-emitting element, between the source or drain electrode of the lighting control switch and the gate electrode thereof, and between a wiring connecting the lighting control switch and the light-emitting element and other wirings. The parasitic capacitor stores a potential supplied during an emission period of a certain frame and supplies current toward the light-emitting element when an emission period of the next frame starts. Then, the light-emitting element emits weak light even when the driving transistor does not supply current. Thus, since the lowest luminance of the light-emitting element becomes equal to or larger than the luminance of weak emission, the contrast deteriorates.

The present invention has been made in view of the above problems, and an object of the present invention is to provide an image display device in which weak emission by a parasitic capacitor is suppressed to thereby improve the contrast and a method for driving the image display device.

### SUMMARY OF THE INVENTION

Among the inventions disclosed in the present application, the outline of the representative aspects will be explained briefly.

(1) An image display device including a light-emitting element that emits light at a luminance corresponding to an amount of current in an emission period; a storage capacitor to which a display potential is supplied to one end thereof before the emission period and which stores a voltage corresponding to the display potential; a driving transistor that adjusts an amount of current flowing in a drain electrode thereof in accordance with a potential difference between a gate electrode thereof and a source electrode thereof occurring due to the voltage stored by the storage capacitor; a lighting control switch which is connected in series with the light-emitting element from the drain electrode of the driving transistor and which is turned on in the emission period; and a discharge switch that connects a node in a current path from the driving transistor to the light-emitting element, through which a current flows when the lighting control switch is turned on, to a wiring that supplies a discharge potential before the emission period.

(2) The image display device according to (1), wherein the discharge switch electrically connects one end of the light-emitting element close to the driving transistor to the wiring that supplies the discharge potential before the emission period.

(3) The image display device according to (2), wherein one end of the light-emitting element is connected to the drain electrode of the driving transistor through the lighting control switch, and wherein the lighting control switch is turned off until the emission period starts after the discharge switch electrically connects one end of the light-emitting element close to the driving transistor to the wiring that supplies the discharge potential.

(4) The image display device according to any one of (1) to (3), further including a reset switch that connects the other end of the storage capacitor to the drain electrode of the driving transistor during a period when the discharge switch connects the node in the current path to the wiring that supplies the discharge potential.

(5) The image display device according to any one of (1) to (4), further including: a data line that supplies the display potential; an emission control signal line; a select switch; and an emission signal control switch, wherein the one end of the storage capacitor is connected to the data line through the select switch and connected to the emission control signal line through the emission signal control switch, and wherein the other end of the storage capacitor is connected to the gate electrode of the driving transistor.

(6) The image display device according to (5), wherein the discharge switch connects the node in the current path to the data line before the emission period, and wherein the data line supplies the discharge potential when the data line is connected to the node in the current path.

(7) The image display device according to (5), wherein the discharge switch connects the node in the current path to the emission control signal line before the emission period, and wherein the emission control signal line supplies the discharge potential when the emission control signal line is connected to the node in the current path.

(8) A method for driving an image display device which includes a light-emitting element, a storage capacitor that stores a voltage, and a driving transistor including a source electrode, a drain electrode, and a gate electrode. The method including an emission step of setting a current path from the drain electrode of the driving transistor to the light-emitting element and causing the light-emitting element to emit light in accordance with an amount of current which is adjusted by the driving transistor in accordance with the voltage stored by the storage capacitor; a discharge step of supplying a discharge potential to a node in the current path before the emission step; and a storage step of supplying a display potential to one end of the storage capacitor before the emission step and storing a potential difference corresponding to the display potential in the storage capacitor.

(9) An image display device including a data line; an emission control signal line; a light-emitting element that emits light in accordance with an amount of current in an emission period; a driving transistor; a storage capacitor having one end that is connected to a gate electrode of the driving transistor; a select switch that is provided between one other end of the storage capacitor and the data line; an emission signal control switch that is provided between the other end of the storage capacitor and the emission control signal line; a reset switch that is provided between the gate electrode and a drain electrode of the driving transistor; a lighting control switch that is provided between one end of the light-emitting element and the drain electrode of the driving transistor; and a discharge switch which is provided between the one end of the light-emitting element and the data line and which is turned on before the emission period.

(10) An image display device including: a data line; an emission control signal line; a light-emitting element that emits light in accordance with an amount of current in an emission period; a driving transistor; a storage capacitor having one end that is connected to a gate electrode of the driving transistor; a select switch that is provided between one other end of the storage capacitor and the data line; an emission signal control switch that is provided between the other end of the storage capacitor and the emission control signal line; a reset switch that is provided between the gate electrode and a drain electrode of the driving transistor; a lighting control switch that is provided between one end of the light-emitting element and the drain electrode of the driving transistor; and a discharge switch which is provided between one end of the lighting control switch close to the driving transistor and the data line and which is turned on before the emission period.

(11) An image display device including: a data line; an emission control signal line; a light-emitting element that emits light in accordance with an amount of current in an emission period; a driving transistor; a storage capacitor having one end that is connected to a gate electrode of the driving transistor; a select switch that is provided between one other end of the storage capacitor and the data line; an emission signal control switch that is provided between the other end of the storage capacitor and the emission control signal line; a reset switch that is provided between the gate electrode and a drain electrode of the driving transistor; a lighting control switch that is provided between one end of the light-emitting element and the drain electrode of the driving transistor; and a discharge switch which is provided between one end of the lighting control switch close to the driving transistor and the emission control signal line and which is turned on before the emission period.

According to the above aspects of the present invention, it is possible to suppress weak emission by a parasitic capacitor in an image display device to thereby improve the contrast.

### BRIEF DESCRIPTION OF THE DRAWINGS

FIG. 1 is a diagram showing an example of a circuit configuration of an organic EL display device according to a first embodiment.

FIG. 2 is a circuit diagram showing an example of the configuration of each pixel circuit according to the first embodiment.

FIG. 3 is a waveform diagram showing an example of changes in potentials of a reset control line, a lighting control line, a discharge control line, an emission control signal line, and a data line corresponding to the pixel circuit according to the first embodiment.

FIG. 4A is a diagram showing the state of switches in the pixel circuit during a precharge period.

FIG. 4B is a diagram showing the state of switches in the pixel circuit during a data storage period.

FIG. 4C is a diagram showing the state of switches in the pixel circuit during an emission period.

FIG. 5 is a circuit diagram showing another example of the configuration of each pixel circuit according to the first embodiment.

FIG. 6 is a diagram showing the relationship between voltage applied to a light-emitting element and luminance.

FIG. 7 is a circuit diagram showing an example of the configuration of each pixel circuit according to a second embodiment.

FIG. 8 is a waveform diagram showing an example of changes in potentials of a reset control line, a lighting control line, a discharge control line, an emission control signal line, and a data line corresponding to the pixel circuit according to the second embodiment.

FIG. 9A is a diagram showing the state of switches in the pixel circuit during a precharge period.

FIG. 9B is a diagram showing the state of switches in the pixel circuit during a data storage period.

FIG. 9C is a diagram showing the state of switches in the pixel circuit during an emission period.

FIG. 10 is a diagram showing an example of a pixel circuit of an organic EL display device according to the related art.

### DETAILED DESCRIPTION OF THE INVENTION

Hereinafter, embodiments of the present invention will be described based on the accompanying drawings. Constituent elements having the same functions will be denoted by the same reference characters, and description thereof will not be provided.

In the following description, a case in which the present invention is applied to an organic EL display device which is a kind of image display device using a light-emitting element will be described.

[First Embodiment]

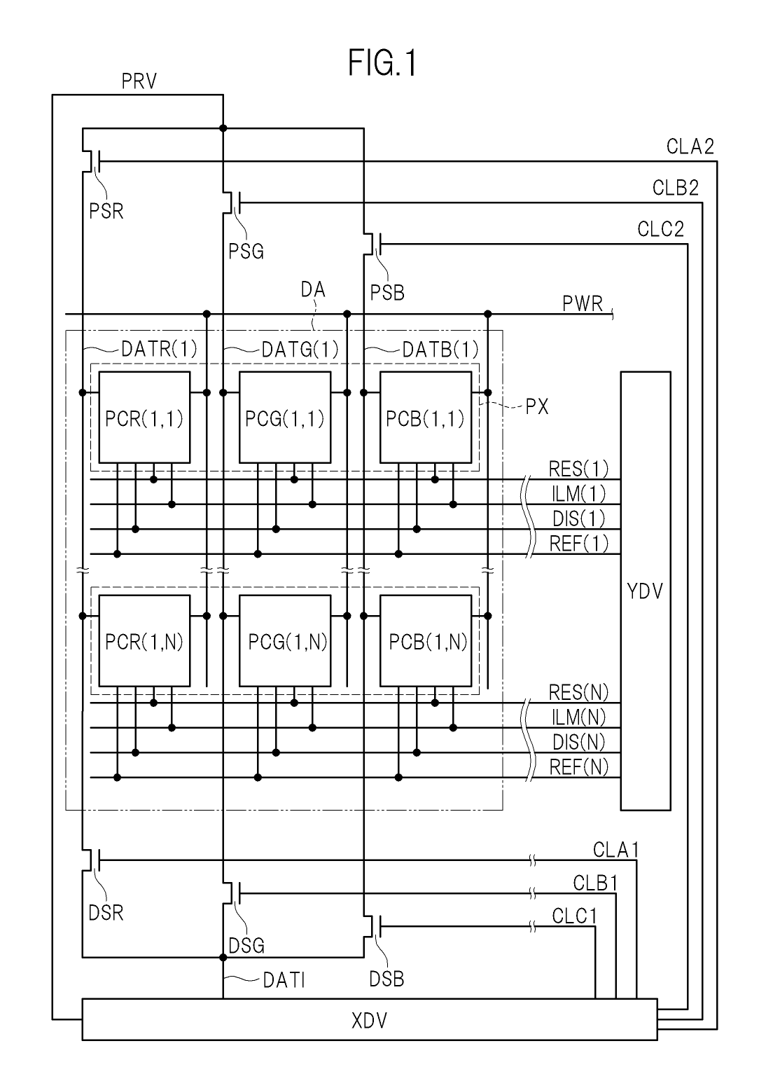

An organic EL display device physically includes an array substrate, a flexible printed substrate, and a driver integrated circuit. A display area DA in which an image is displayed is disposed on the array substrate. FIG. 1 is a diagram showing an example of a circuit configuration of an organic EL display device according to the first embodiment. The circuit shown in FIG. 1 is mainly formed on the array substrate and the driver integrated circuit. The display area DA is on the array substrate of the organic EL display device, and pixels PX are disposed on the display area DA in a matrix form. In each of the pixel areas, three pixel circuits PCR, PCG, and PCB are arranged in the horizontal direction of the drawing. The pixel circuit PCR displays red, the pixel circuit PCG displays green, and the pixel circuit PCB displays blue. In the following description, the pixel circuits PCR, PCB, and PCG will be referred to as pixel circuits PC when the colors displayed by them are not distinguished. In the display area DA, pixels PX of M columns by N rows are disposed. A red pixel circuit PCR constituting a pixel PX on the n-th row and the m-th column will be denoted by PCR (m,n), and similarly, a green pixel circuit PCG and a blue pixel circuit PCB constituting the same pixel PX will be denoted by PCG(m,n) and PCB(m,n), respectively. Pixel circuits PC of (3×M) columns by N rows are arranged in the display area, and in the example of FIG. 1, pixel circuits PC arranged on the same column display the same color.

In the display area DA, data lines DATR, DATG, DATB (hereinafter referred to as data lines DAT when these data lines are not distinguished) and a power line PWR for supplying a power potential Voled extend in the vertical direction of the drawing so as to correspond to each column of the pixel circuits PC. Moreover, a reset control line RES, a lighting control line ILM, a discharge control line DIS, and an emission control signal line REF extend in the horizontal direction of the drawing so as to correspond to each row of the pixel circuits PC. RGB changeover switches DSR, DSG, and DSB provided in correspondence to the data lines DATR, DATG, and DATB, an integrated data line DATI, and a data line driving circuit XDV are formed in a region of the array substrate on the lower side of the display area DA in the drawing. Discharge potential supply switches PSR, PSG, PSB, and a discharge potential supply line PRV are formed in a region of the array substrate on the upper side of the display area DA in the drawing. A vertical scanning circuit YDV is formed in a region of the array substrate on the right side of the display area DA in the drawing. Apart of each of the data line driving circuit XDV and the vertical scanning circuit YDV is formed in the driver integrated circuit.

Pixel circuits PC connected to the same data line DAT display the same color. In the following description, a data line DATR corresponding to an array of pixel circuits PCR constituting an array of pixels on the m-th column will be denoted by DATR(m), and similarly, data lines DATG and DATB corresponding to the arrays of pixel circuits PCG and PCB constituting the array of pixels will be denoted by DATG(m) and DATB(m), respectively. A certain data line DAT supplies a data signal to a plurality of pixel circuits PC within the corresponding column. Moreover, the respective numbers of reset control lines RES, lighting control lines ILM, discharge control lines DIS, and emission control signal lines REF are the same number (N) as the number of rows of the pixel circuits PC. A reset control line RES, a lighting control line ILM, a discharge control line DIS, and an emission control signal line

REF corresponding to the rows of a pixel circuit PC on the n-th row will be denoted by RES(n), ILM(n), DIS(n), and REF(n), respectively. One set of ends of the reset control line RES, the lighting control line ILM, the discharge control line DIS, and the emission control signal line REF are connected to the vertical scanning circuit YDV.

The RGB changeover switches DSR, DSG, and DSB are n-channel thin-film transistors. The RGB changeover switches DSR, DSG, and DSB are provided in correspondence to each column of pixels. The number of the RGB changeover switches DSR, the number of the RGB changeover switches DSG and the number of the RGB changeover switches are M respectively. A RGB changeover control line CLA1 is connected to the gate electrode of the RGB changeover switch DSR, a RGB changeover control line CLB1 is connected to the gate electrode of the RGB changeover switch DSG, and a RGB changeover control line CLC1 is connected to the gate electrode of the RGB changeover switch DSB.

One end of the RGB changeover switch DSR is connected to the lower end of a data line DATR(m) corresponding to the pixel circuit

PCR among the data lines DAT corresponding to the m-th column of pixels. The other end of the RGB changeover switch DSR is connected to one end of an integrated data line DATI corresponding to the pixels on the m-th column among the M integrated data lines DATI formed in correspondence to the columns of pixels. Similarly, the lower end of the data line DATG(m) is connected to one end of the corresponding integrated data line DATI through the RGB changeover switch DSG, and the lower end of the data line DATB(m) is connected to one end of the corresponding integrated data line DATI through the RGB changeover switch DSB . The other end of the integrated data line DATI is connected to the data line driving circuit XDV.

The drain electrodes of the RGB changeover switches DSR, DSG, and DSB are connected to the integrated data line DATI, and the source electrodes thereof are connected to the corresponding data lines DAT. The polarities of the source electrode and the drain electrode of the thin film transistor are not determined by the structure thereof. The polarities are determined by the direction of current flowing through the thin film transistor and whether the thin film transistor is an n-channel type or a p-channel type. Thus, the connection destination of the source electrode and the connection destination of the drain electrode of the thin film transistor may be reversed.

The discharge potential supply switches PSR, PSG, and PSB are n-channel thin-film transistors, and M supply switches are provided in correspondence to each column of pixels. Discharge potential supply control lines CLA2, CLB2, and CLC2 are connected to the gate electrodes of the discharge potential supply switches PSR, PSG, and PSB, respectively.

One end of the discharge potential supply switch PSR is connected to the upper end of the data line DATR(m) corresponding to the pixel circuit PCR among the data lines DAT corresponding to the m-th column of pixels. The other end of the discharge potential supply switch PSR is connected to a discharge potential supply line PRV. Similarly, the upper end of the data line DATG(m) is connected to the discharge potential supply line PRV through the discharge potential supply switch PSG, and the upper end of the data line DATB (m) is connected to the discharge potential supply line PRV through the discharge potential supply switch PSB. The discharge potential supply line PRV is also connected to the data line driving circuit XDV, and supplies a discharge potential for discharging charges in the pixel circuit PC.

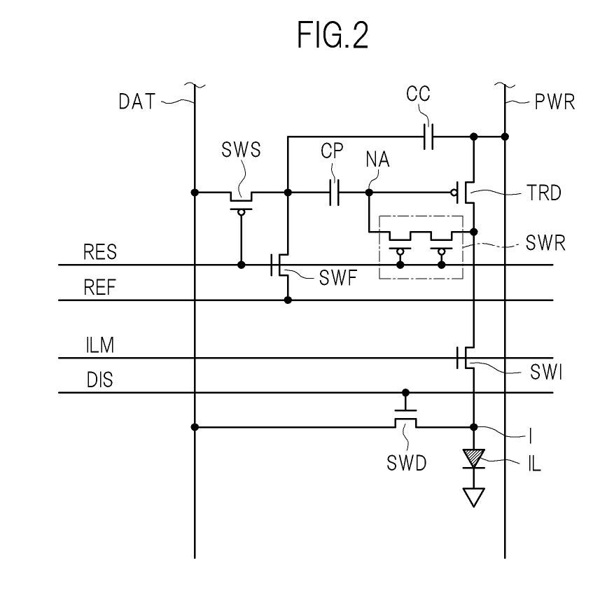

FIG. 2 is a circuit diagram showing an example of the configuration of each pixel circuit PC according to the first embodiment. Each pixel circuit PC includes a light-emitting element IL, a driving transistor TRD, a storage capacitor CP, an auxiliary capacitor CC, a lighting control switch SWI, a reset switch SWR, a select switch SWS, an emission signal control switch SWF, and a discharge switch SWD. The light-emitting element IL is an organic EL element, and since it generally has the characteristics of a diode, it is also referred to as an organic light-emitting diode (OLED). A reference potential is supplied to one end of the light-emitting element IL from a reference potential supply wiring (not shown). The driving transistor TRD is a p-channel thin film transistor and controls current (in particular, the amount of current) flowing from the power line PWR to the light-emitting element IL in accordance with a difference between the potential applied to a gate electrode thereof and the potential applied to a source electrode thereof. The source electrode of the driving transistor TRD is connected to the power line PWR, and a drain electrode of the driving transistor TRD is connected to the other end of the light-emitting element IL through the lighting control switch SWI. One end of the storage capacitor CP is connected to the gate electrode of the driving transistor TRD. The other end of the storage capacitor CP is connected to one end of the select switch SWS, and the other end of the select switch SWS is connected to the data line DAT. Moreover, the other end of the storage capacitor CP is also connected to one end of the emission signal control switch SWF, and the other end of the emission signal control switch SWF is connected to the emission control signal line REF. A light-emitting element IL included in the pixel circuit PCR emits red light, a light-emitting element IL included in the pixel circuit PCG emits green light, and a light-emitting element IL included in the pixel circuit PCB emits blue light.

One end of the auxiliary capacitor CC is connected to the other end of the storage capacitor CP, and the other end of the auxiliary capacitor CC is connected to the source electrode of the driving transistor TRD. Although the auxiliary capacitor CC is provided to stabilize the potential of the other end of the storage capacitor CP, it may not be provided. The gate electrode and the drain electrode of the driving transistor TRD are connected by the reset switch SWR. The discharge switch SWD is provided between one end of the light-emitting element IL close to the lighting control switch SWI and the data line DAT. The reset switch SWR is a double-gate and p-channel thin film transistor, the select switch SWS is a p-channel thin film transistor, and the emission signal control switch SWF is an n-channel thin film transistor. The gate electrodes of the reset switch SWR, the select switch SWS, and the emission signal control switch SWF are connected to the reset control line RES. The lighting control switch SWI is an n-channel thin film transistor, and the gate electrode thereof is connected to the lighting control line ILM. The discharge switch SWD is an n-channel thin film transistor, and the gate electrode thereof is connected to the discharge control line DIS.

The reference potential is a potential serving as the reference in relation to the power potential Voled supplied from the power line PWR, the potential supplied to the data line DAT, the potential supplied to the gate electrodes of the thin-film transistors used for the switches such as the lighting control switch SWI, and the like. The reference potential may not always be supplied from a grounded electrode.

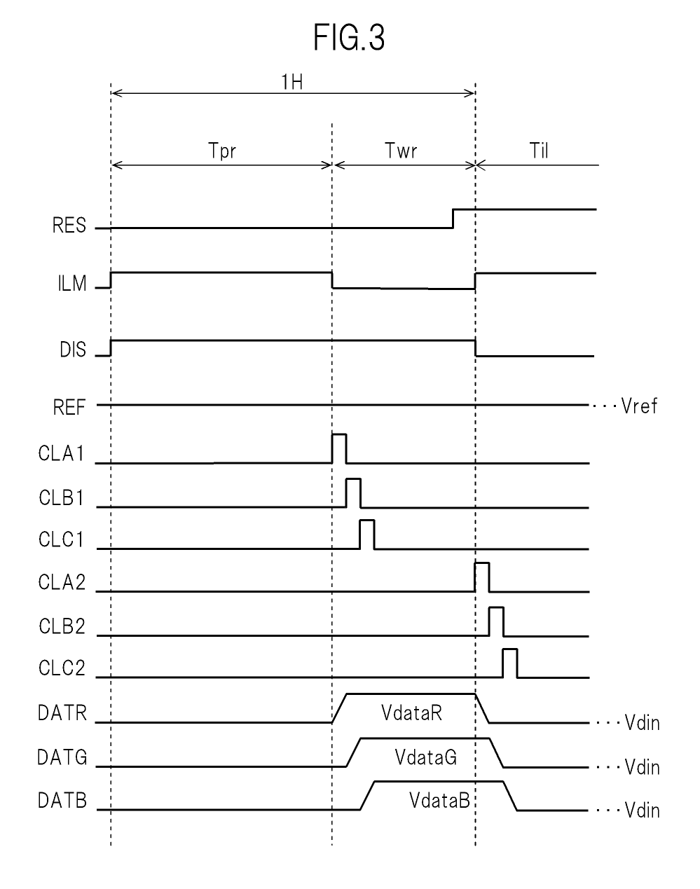

Next, a method for driving the organic EL display device according to the present embodiment will be described. FIG. 3 is a waveform diagram showing an example of changes in potentials of the reset control line RES, the lighting control line ILM, the discharge control line DIS, the emission control signal line REF, the RGB changeover control lines CLA1, CLB1, and CLC1, and the discharge potential supply control lines CLA2, CLB2, and CLC2, and the data lines DATR, DATG, and DATB corresponding to the pixel circuit PC according to the first embodiment. In the drawing, only signals of the pixel circuit PC on a certain row are shown.

An operation of causing a certain pixel circuit to perform light emission is performed in the order of a precharge operation, a data storage operation, and a light emitting operation. The precharge operation is an operation for decreasing the gate potential of the driving transistor TRD, and a period of performing this operation is referred to as a precharge period Tpr. The data storage operation is an operation for causing the driving transistor TRD to generate the threshold voltage thereof and causing the storage capacitor CP to store a potential difference corresponding to a display grayscale and the threshold voltage, and a period of performing this operation is referred to as a data storage period Twr. The light emitting operation is an operation of causing the light-emitting element IL to emit light, and a period of performing this operation is referred to as an emission period Til. In this example, the precharge period Tpr and the data storage period Twr are continuous, and the length of both periods is one horizontal period (1H). The pixel circuits PC are arranged in a matrix form, and the vertical scanning circuit YDV scans the pixel circuits PC row by row every horizontal period. In the example of this diagram, when pixel circuits PC on the n-th row are in the precharge period Tpr or the data storage period Twr, the pixel circuits PC on the rows other than the n-th row are in the emission period Til. In the next horizontal period 1H, pixel circuits PC on the (n+1)-th row are in the precharge period Tpr or the data storage period Twr, and the pixel circuits PC on the rows other than the (n+1)-th row are in the emission period Til. After pixel circuits on the last row in the display area DA are scanned, and a vertical blanking period has passed, the vertical scanning circuit YDV sequentially scans the pixel circuits from the first row in order to display the next frame.

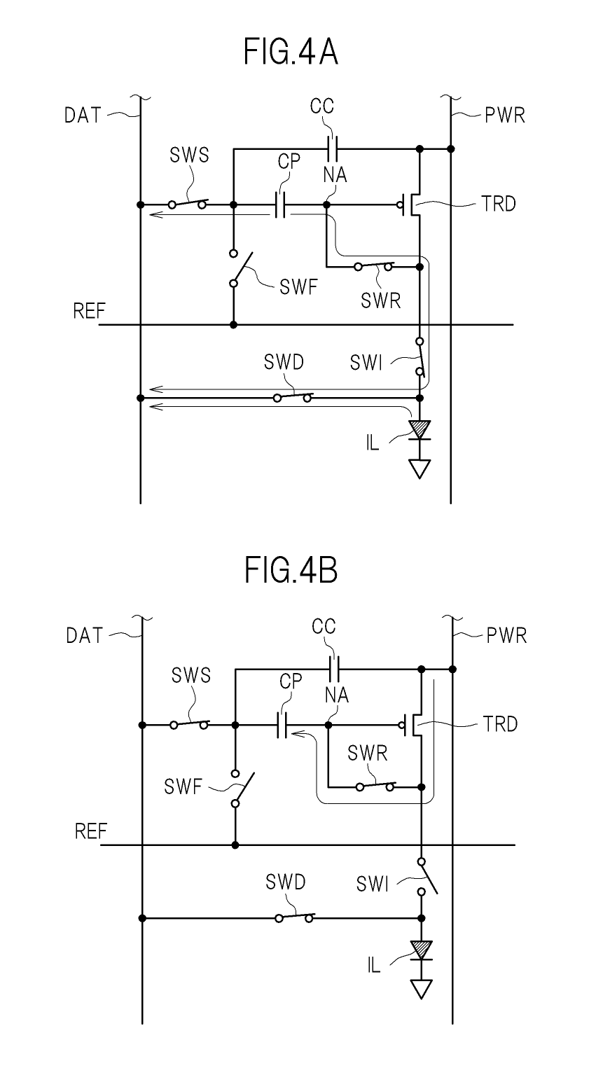

FIGS. 4A to 4C are diagrams showing the states of the lighting control switch SWI, the reset switch SWR, the select switch SWS, the emission signal control switch SWF, and the discharge switch SWD in the pixel circuit PC shown in FIG. 3 in the respective periods. The driving method will be described with reference to FIG. 3 and FIGS. 4A to 4C.

Before the precharge period Tpr, the light-emitting element IL emits light with a display grayscale used in the previous frame. In the precharge period Tpr, the vertical scanning circuit YDV supplies a low-level potential to the reset control line RES and supplies a high-level potential to the lighting control line ILM and the discharge control line DIS. The potential Vref of the emission control signal is applied to the emission control signal line REF. Then, the select switch SWS, the reset switch SWR, the lighting control switch SWI, and the discharge switch SWD are turned on, and the emission signal control switch SWF is turned off. FIG. 4A is a diagram showing the states of these switches in the pixel circuit PC. In this way, one end of the storage capacitor CP close to the gate electrode of the driving transistor TRD is connected to the data line DAT through the reset switch SWR, the lighting control switch SWI, and the discharge switch SWD. The other end of the storage capacitor CP is connected to the data line DAT through the select switch SWS. Here, a potential Vdin lower than the potential at which the light-emitting element IL emits light is supplied to the data line DAT, and charges stored in a parasitic capacitor generating in the light-emitting element IL, the lighting control switch SWI, and the wiring between the driving transistor TRD and the light-emitting element IL are discharged. Moreover, the same potential Vdin is supplied to the other end of the storage capacitor CP, the charges stored in the storage capacitor CP are also discharged (precharged), and the potential Vdin of the gate electrode of the driving transistor TRD becomes a potential sufficiently low for the driving transistor to be turned on. The reset switch SWR, the lighting control switch SWI, and the discharge switch SWD function as precharge switches for precharging the storage capacitor CP. In the precharge period Tpr, although current flows from the power line PWR through the drain electrode of the driving transistor TRD, the current is caused by the discharge switch SWD to flow to the data line DAT rather than the light-emitting element IL. In the pixel circuit PC shown in FIG. 2, in the precharge period Tpr, the data line DAT is electrically connected to one end of the light-emitting element IL, and the reset switch SWR and the lighting control switch SWI are turned on, whereby the routes for discharging the charges of the storage capacitor CP and the parasitic capacitor overlap each other. As a result, discharge of the storage capacitor CP and the parasitic capacitor is realized without increasing the number of switches.

The route for discharging the charges of the storage capacitor CP to a discharge wiring such as the data line DAT and the route for discharging the charges of the parasitic capacitor may be divided. For example, a switch may be provided between one end of the storage capacitor CP close to the driving transistor TRD and a discharge wiring, and the switch and the discharge switch SWD may be turned on in the precharge period Tpr.

When the precharge period Tpr ends, and the data storage period Twr starts, the vertical scanning circuit YDV supplies a low-level potential to the lighting control line ILM, and the lighting control switch SWI is turned off. FIG. 4B is a diagram showing the states of these switches in the pixel circuit PC in the data storage period Twr . When the data storage period Twr starts, the reset switch SWR is turned on. In this way, a current path extending from the power line PWR to one end of the storage capacitor CP through the drain electrode and the gate electrode of the driving transistor TRD as denoted by an arrow is secured, and current flows along the current path. When current flows, charges are stored in the storage capacitor CP, and the potential of the gate electrode of the driving transistor TRD starts rising. When a sufficient period has elapsed, the voltage between the gate electrode and the source electrode of the driving transistor TRD becomes the threshold voltage of the driving transistor TRD, and no current flows. At this time, the data line DAT supplies a display potential Vdata representing a grayscale to be displayed by the pixel circuit PC to the other end of the storage capacitor CP, and the storage capacitor CP stores a voltage generated by the display potential and the threshold voltage. If the threshold voltage of the driving transistor TRD is Vth, and the data storage period Twr is sufficiently long, the voltage applied across both ends of the storage capacitor CP at the end of the data storage period Twr is “Voled-|Vth|-Vdata.” Since no current is supplied to a node (hereinafter denoted by a node I) between one end of the light-emitting element IL close to the driving transistor TRD and the lighting control switch SWI, the potential of the node I is maintained.

Here, in the data storage period Twr, the data line driving circuit XDV sequentially supplies a data signal corresponding to the display potential Vdata to the data line DATR, the data line DATG, and the data line DATB. At the start of the data storage period Twr, the RGB changeover control line CLA1 is at the high level, the RGB changeover switch DSR is turned on, and the integrated data line DATI and the data line DATR are connected. The data line driving circuit XDV writes the data signal to the data line DATR through the integrated data line DATI. Subsequently, the RGB changeover control line CLB1 instead of the RGB changeover control line CLA1 is at the high level, and the data line driving circuit XDV writes the data signal to the data line DATG through the integrated data line DATI. Similarly to the above, the RGB changeover control line CLC1 instead of the RGB changeover control line CLB1 is at the high level, and the data line driving circuit XDV writes the data signal to the data line DATB through the integrated data line DATI. After writing to the data line, the RGB changeover switch DSB is turned off. The data lines DATR, DATG, and DATB maintain the potentials of the supplied data signals even when the RGB changeover switches DSR, DSG, and DSB are turned off. This is because parasitic capacitors are generated between the data lines DATR, DATG, and DATB and wirings extending in the horizontal direction such as the reset control line RES, and these parasitic capacitors maintain the potentials. In this way, even when the data signal is not supplied during the data storage period Twr as described above, the display potential Vdata is supplied to the other end of the storage capacitor CP at the end of the data storage period Twr. When the potential of the reset control line RES changes to the high level at the end of the data storage period Twr, and the reset switch SWR and the select switch SWS are turned off, the storage capacitor CP stores the above-described voltage. Moreover, the emission signal control switch SWF is turned on, and the potential Vref of the emission control signal is supplied to one end of the storage capacitor CP close to the data line DAT.

In the subsequent emission period Til, the potential of the lighting control line ILM changes to the high level, and the lighting control switch SWI is turned on, the potential of the discharge control line DIS changes to the low level, and the discharge switch SWD is turned off. FIG. 4C is a diagram showing the states of the switches at this point in time. The current which flows through the driving transistor TRD indicated by an arrow changes in accordance with a difference between the potential of the data signal and the potential Vref of the emission control signal. The potential applied to the gate electrode of the driving transistor TRD is “Voled-|Vth|-(Vdata-Vref) ”

Since the amount of current which flows through the driving transistor TRD is determined by a value obtained by subtracting the threshold voltage from the potential difference between the gate and the source, it is possible to control the amount of current regardless of fluctuation of the threshold voltage during manufacturing of the driving transistor TRD. Therefore, the light-emitting element IL emits light at a luminance corresponding to the potential of the data signal.

Here, immediately before the lighting control switch SWI is turned on in the emission period Til, since no charge is stored in at least a parasitic capacitor generating between both ends of the light-emitting element IL and a parasitic capacitor generating between the node I and other wirings, no charge flows from these parasitic capacitors to the light-emitting element IL even when the potentials of nodes associated with the parasitic capacitor are changed for some reason when the lighting control switch SWI is turned on. This is because the discharge switch SWD has discharged the charges of the parasitic capacitor generating in a node within the current path from the driving transistor to the light-emitting element before the emission period Til of the present frame and after the emission period Til of a frame previous to the present frame. Thus, even when the data signal written to the storage capacitor CP represents the darkest grayscale, and no current is flowed toward the light-emitting element IL by the driving transistor TRD, emission of the light-emitting element IL is suppressed, and the contrast of the display can be improved.

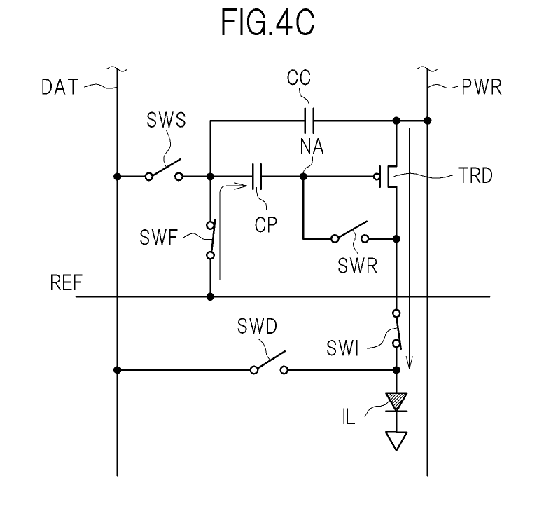

Here, the configuration of the pixel circuit PC may be different from the example shown in FIG. 2. FIG. 5 is a circuit diagram showing another example of the configuration of each pixel circuit PC according to the first embodiment. The pixel circuit PC shown in FIG. 5 mainly has two differences from the pixel circuit PC shown in FIG. 2. One difference is that one end of the discharge switch SWD is connected between one end of the lighting control switch SWI close to the driving transistor TRD and the data line DAT, and the other is that the auxiliary capacitor CC is provided between the gate electrode and the source electrode of the driving transistor TRD. Potentials are supplied to the reset control line RES, the emission control signal line REF, the discharge control line DIS, and the lighting control line ILM at the timing as shown in FIG. 3. In the predetermined Tpr, the lighting control switch SWI and the discharge switch SWD are turned on, and charges of a node in the current path occurring in the emission period, that is, a parasitic capacitor generating between the driving transistor TRD and the light-emitting element IL are discharged.

The discharge switch SWD may be provided between one end of the lighting control switch SWI close to the driving transistor TRD and the emission control signal line REF.

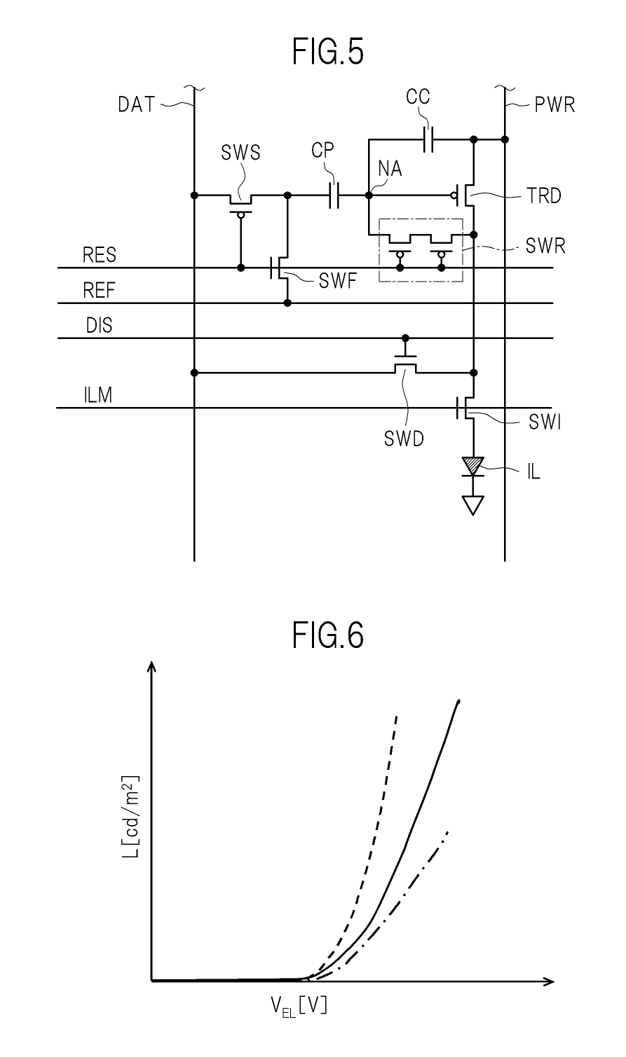

FIG. 6 is a diagram showing the relationship between voltage V_{EL} applied to the light-emitting element IL and luminance L. A solid line in the graph shows the relationship for a red light-emitting element IL, a broken line shows the relationship for a green light-emitting element IL, and a one-dot chain line shows the relationship for a blue light-emitting element IL. An emission start voltage Vis is defined as a voltage when each light-emitting element IL emits light at a lower-limit luminance (for example, 0.01 cd/m²) that can be measured. As can be understood from the characteristics shown by the lines, the light-emitting element IL starts emitting light when the voltage exceeds a certain emission start voltage Vis, and the luminance increases as the voltage increases. Moreover, the emission start voltage Vis is different depending on the color of the light-emitting element IL: specifically, the emission start voltage Vis is about 2.3 V for the red light-emitting element IL, about 2.2 V for the green light-emitting element IL, and about 2.6 V for the blue light-emitting element IL. If a reference potential is supplied to one end of the light-emitting element IL, when a potential (for example, 2.0 V or lower) smaller than the emission start voltage Vis is applied to the emission control signal line REF, it is possible to suppress weak emission as in the case of the pixel circuits shown in FIGS. 2 and 5. The vertical scanning circuit YDV may supply a potential lower than the emission start voltage Vis to the emission control signal line REF in a period when the discharge switch SWD is turned on and supply a voltage appropriate for emission in the emission period Til.

[Second Embodiment]

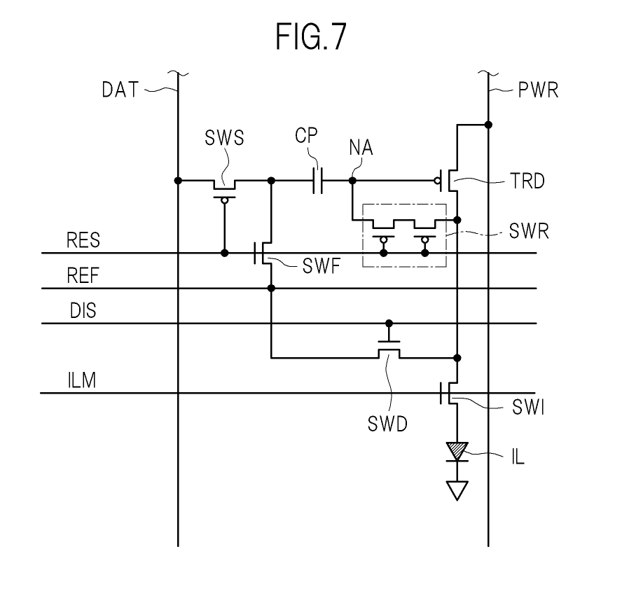

A pixel circuit of the second embodiment is different from the pixel circuit of the first embodiment, in that one end of the discharge switch SWD is connected to the emission control signal line REF rather than the data line DAT. The discharge switch SWD is provided between one end of the lighting control switch SWI close to the driving transistor TRD and the emission control signal line REF. In the following description, the difference of the second embodiment from the first embodiment will be mainly described. FIG. 7 is a circuit diagram showing an example of the configuration of each pixel circuit PC according to the second embodiment. In the pixel circuit PC shown in FIG. 7, the auxiliary capacitor CC is not illustrated.

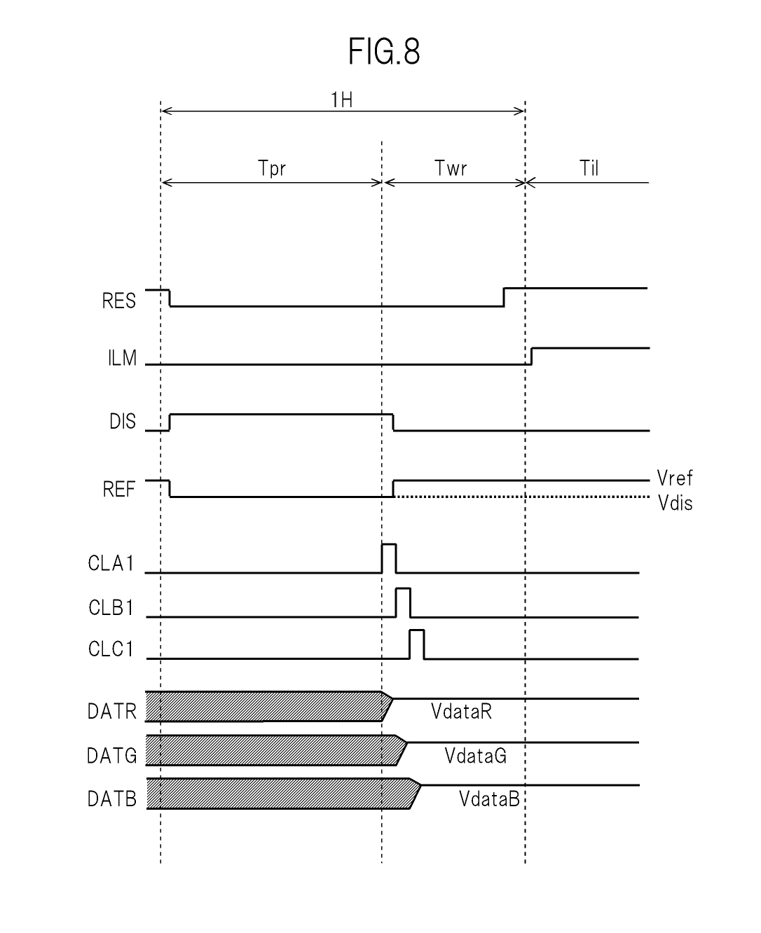

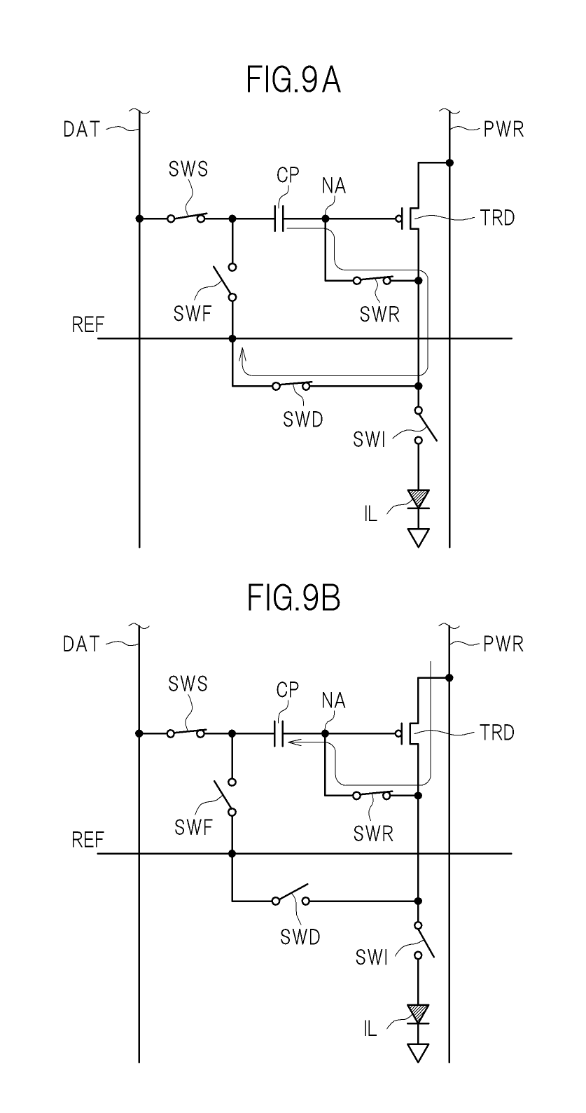

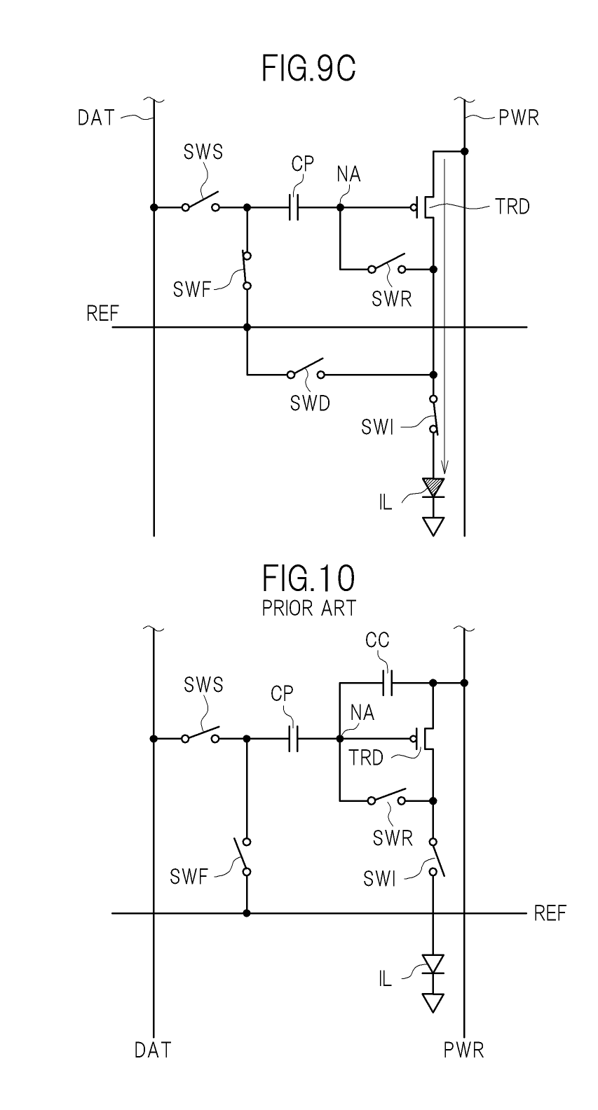

Next, a method for driving the organic EL display device according to the second embodiment will be described. FIG. 8 is a waveform diagram showing an example of changes in potentials of the reset control line RES, the lighting control line ILM, the discharge control line DIS, the emission control signal line REF, the RGB changeover control line CLA1, CLB1, and CLC1, and the data line corresponding to the pixel circuit PC according to the second embodiment. Similarly to the first embodiment, the pixel circuits PC are scanned row by row, and in a certain row, the precharge period Tpr, the data storage period Twr, and the emission period Til occur in that order. FIGS. 9A to 9C are diagrams showing the states of the lighting control switch SWI, the reset switch SWR, the select switch SWS, the emission signal control switch SWF, and the discharge switch SWD in the pixel circuit PC shown in FIG. 7 in the respective periods.

In the precharge period Tpr, the vertical scanning circuit YDV supplies a low-level potential to the reset control line RES and the lighting control line ILM and supplies a high-level potential to the discharge control line DIS. Then, the select switch SWS, the reset switch SWR, and the discharge switch SWD are turned on, and the lighting control switch SWI and the emission signal control switch SWF are turned off. FIG. 9A is a diagram showing the states of these switches in the pixel circuit PC. One end of the storage capacitor CP is connected to the data line DAT through the select switch SWS, and the other end of the storage capacitor CP is connected to the emission control signal line REF through the reset switch SWR and the discharge switch SWD. The vertical scanning circuit YDV supplies a discharge potential Vdis lower than the emission start voltage Vis to the emission control signal line REF, and the charges stored in a parasitic capacitor generating in the lighting control switch SWI and a parasitic capacitor generating in a wiring between the driving transistor TRD and the lighting control switch SWI are discharged. Here, the discharge potential Vdis is also a low potential at which no current flows between the source and the drain of the driving transistor TRD. Then, the storage capacitor CP is also precharged, and current flows to the driving transistor TRD in the next data storage period Twr, whereby the threshold voltage of the driving transistor TRD can be generated.

When the next data storage period Twr occurs, the vertical scanning circuit YDV supplies a low-level potential to the discharge control line DIS, and the discharge switch SWD is turned off. Moreover, the vertical scanning circuit YDV supplies the potential Vref of the emission control signal to the emission control signal line REF. FIG. 9B is a diagram showing the states of the switches in the pixel circuit PC in the data storage period Twr. When the data storage period Twr starts, current flows from the power line PWR to the gate electrode through the drain electrode of the driving transistor TRD as indicated by an arrow. When a sufficient period has elapsed, the current does not flow, and similarly to the first embodiment, the voltage between the gate electrode and the source electrode of the driving transistor TRD becomes the threshold voltage of the driving transistor TRD. When the data line DAT supplies a display potential Vdata representing a grayscale to be displayed by the pixel circuit PC to one end of the storage capacitor CP by the same method as the first embodiment, the storage capacitor CP stores a voltage generated by the display potential and the threshold voltage at the point in time when the data storage period Twr ends, and the reset switch SWR is turned off.

The data line driving circuit XDV may sequentially supply the data signal to the data lines DATR, DATG, and DATB through the RGB changeover switches DSR, DSG, and DSB in the precharge period Tpr rather than the data storage period Twr.

In the subsequent emission period Til, the vertical scanning circuit YDV supplies a high-level potential to the reset control line RES and the lighting control line ILM. FIG. 9C shows the states of the switches at that point in time. The select switch SWS and the reset switch SWR are turned off, and the emission signal control switch SWF and the lighting control switch SWI are turned on. Then, as indicated by an arrow, the current flowing through the light-emitting element IL is controlled by the driving transistor TRD, and the light-emitting element IL emits light at a luminance corresponding to the data signal. Here, since the charges stored in the parasitic capacitor generating in the lighting control switch SWI close to the driving transistor TRD are discharged in the precharge period Tpr, weak emission of the light-emitting element IL when no current is flowed by the driving transistor TRD is suppressed.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device comprising:
a light-emitting element that emits light at a luminance corresponding to an amount of current in an emission period;
a storage capacitor to which a display potential is supplied to one end thereof before the emission period and which stores a voltage corresponding to the display potential;
a driving transistor that adjusts an amount of current flowing in a drain electrode thereof in accordance with a potential difference between a gate electrode thereof and a source electrode thereof occurring due to the voltage stored by the storage capacitor;
a lighting control switch which is connected in series with the light-emitting element from the drain electrode of the driving transistor and which is turned on in the emission period; and
a discharge switch that connects a node in a current path from the driving transistor to the light-emitting element, through which a current flows when the lighting control switch is turned on, to a wiring that supplies a discharge potential before the emission period.

2. The image display device according to claim 1,
wherein the discharge switch electrically connects one end of the light-emitting element close to the driving transistor to the wiring that supplies the discharge potential before the emission period.

3. The image display device according to claim 2,
wherein one end of the light-emitting element is connected to the drain electrode of the driving transistor through the lighting control switch, and
wherein the lighting control switch is turned off until the emission period starts after the discharge switch electrically connects one end of the light-emitting element close to the driving transistor to the wiring that supplies the discharge potential.

4. The image display device according to claim 1,
further comprising a reset switch that connects the other end of the storage capacitor to the drain electrode of the driving transistor during a period when the discharge switch connects the node in the current path to the wiring that supplies the discharge potential.

5. The image display device according to claim 1, further comprising:
a data line that supplies the display potential;
an emission control signal line;
a select switch; and
an emission signal control switch,
wherein the one end of the storage capacitor is connected to the data line through the select switch and connected to the emission control signal line through the emission signal control switch, and
wherein the other end of the storage capacitor is connected to the gate electrode of the driving transistor.

6. The image display device according to claim 5,
wherein the discharge switch connects the node in the current path to the data line before the emission period, and
wherein the data line supplies the discharge potential when the data line is connected to the node in the current path.

7. The image display device according to claim 5,
wherein the discharge switch connects the node in the current path to the emission control signal line before the emission period, and
wherein the emission control signal line supplies the discharge potential when the emission control signal line is connected to the node in the current path.

8. A method for driving an image display device which includes a light-emitting element, a storage capacitor that stores a voltage, and a driving transistor including a source electrode, a drain electrode, and a gate electrode, comprising:
an emission step of setting a current path from the drain electrode of the driving transistor to the light-emitting element and causing the light-emitting element to emit light in accordance with an amount of current which is adjusted by the driving transistor in accordance with the voltage stored by the storage capacitor;
a discharge step of supplying a discharge potential to a node in the current path before the emission step; and
a storage step of supplying a display potential to one end of the storage capacitor before the emission step and storing a potential difference corresponding to the display potential in the storage capacitor.

9. An image display device comprising:
a data line;
an emission control signal line;
a light-emitting element that emits light in accordance with an amount of current in an emission period;
a driving transistor;
a storage capacitor having one end that is connected to a gate electrode of the driving transistor;
a select switch that is provided between one other end of the storage capacitor and the data line;
an emission signal control switch that is provided between the other end of the storage capacitor and the emission control signal line;
a reset switch that is provided between the gate electrode and a drain electrode of the driving transistor;
a lighting control switch that is provided between one end of the light-emitting element and the drain electrode of the driving transistor; and
a discharge switch which is provided between the one end of the light-emitting element and the data line and which is turned on before the emission period.

10. An image display device comprising:
a data line;
an emission control signal line;
a light-emitting element that emits light in accordance with an amount of current in an emission period;
a driving transistor;
a storage capacitor having one end that is connected to a gate electrode of the driving transistor;
a select switch that is provided between one other end of the storage capacitor and the data line;
an emission signal control switch that is provided between the other end of the storage capacitor and the emission control signal line;
a reset switch that is provided between the gate electrode and a drain electrode of the driving transistor;
a lighting control switch that is provided between one end of the light-emitting element and the drain electrode of the driving transistor; and
a discharge switch which is provided between one end of the lighting control switch close to the driving transistor and the data line and which is turned on before the emission period.

11. An image display device comprising:
a data line;
an emission control signal line;
a light-emitting element that emits light in accordance with an amount of current in an emission period;
a driving transistor;
a storage capacitor having one end that is connected to a gate electrode of the driving transistor;
a select switch that is provided between one other end of the storage capacitor and the data line;
an emission signal control switch that is provided between the other end of the storage capacitor and the emission control signal line;
a reset switch that is provided between the gate electrode and a drain electrode of the driving transistor;
a lighting control switch that is provided between one end of the light-emitting element and the drain electrode of the driving transistor; and
a discharge switch which is provided between one end of the lighting control switch close to the driving transistor and the emission control signal line and which is turned on before the emission period.
